(19) United States
(12) Patent Application Publication
(10) Pub. No.: US 2009/0216586 A1
(43) Pub. Date: Aug. 27, 2009

(54) Method for Modernizing Technical Installations

(76) Inventor: Martin Tackenberg, Forchheim (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/085,273

(22) PCT Filed: Nov. 14, 2006
(86) PCT No.: PCT/US06/44215

§ 371 Date: Feb. 6, 2009

Related U.S. Application Data
(60) Provisional application No. 60/738,451, filed on Nov. 21, 2005.

(30) Foreign Application Priority Data
Nov. 21, 2005 (DE) 10 2005 055 431.8

(51) Int. Cl. G06Q 10/00; G06N 5/02; G06Q 50/00

(52) U.S. Cl. 705/7; 706/52

(57) ABSTRACT

The invention proposes ascertaining at least one technical influencing variable for the technical measured variable and then identifying design measures on the installation which are able to influence the at least one technical influencing variable such that the value of the at least one technical measured variable is altered so as to increase the value retention of the installation. In a subsequent step, further technical influencing variables for the value retention of the installation are identified which have their value altered by the design measures. Thereafter, the changes in the values of the technical influencing variables on account of the design measures and then the change in the value retention of the installation which is linked to the changes in the values of the influencing variables are ascertained.

### CROSS REFERENCE TO RELATED APPLICATIONS

This application is the US National Stage of International Application No. PCT/US06/44215, filed Nov. 14, 2006 and claims the benefit thereof. The International Application claims the benefits of German application No. 10 2005 055 431.8 filed Nov. 21, 2005, and also the benefits of American Provisional Application 60/738,451. All of the applications are incorporated by reference herein in their entirety.

### FIELD OF INVENTION

The invention relates to a method for modernizing technical installations, particularly durable industrial production installations, in accordance with the claims; such a method is known from WO 2005/052840 A1, for example.

### BACKGROUND OF THE INVENTION

Technical installations, for example rolling mills, paper machines, installations for glass manufacture or power plants are designed for one particular purpose. In this context, the conditions which apply at the time of planning and setup on the installation's relevant sales, technology, process and factor markets, and also the associated risks, are taken into account and are also projected into the future.

Particularly in the case of durable industrial production installations or infrastructure installations, not only these conditions but also the incorporation of the installation into a company context change in the course of a life of such an installation. Thus, the products to be produced may be developed further on the basis of customer requirements or technical development, and also the technology used to produce them. The existing technology is subject to wear or another ageing process. In the case of software or IT systems, reference is made to obsolescence in this regard. These circumstances give rise to additional company risks in the course of the installation's life. These may be expressed in lesser quality of the products, in production stoppages, in a lead taken by competitors or else through unused business opportunities, for example.

It is known that servicing is performed at particular intervals of time over the lifecycle of an installation, that maintenance is performed on the basis of events or that large-scale modernization of the installation is performed at longer intervals of time. In some industrial sectors, for example the automobile industry, it has also been found to be economically viable to disregard the durability of the installation and to set up a new production installation, for example in sync with every product innovation.

The drawback of servicing and maintenance is that in the best case it allows the original state, which is to a large extent stipulated by the design, to be restored. There is no improvement or adaptation to new conditions, production factors, products, markets or company strategies.

Although large-scale modernization does not have this drawback it does have the drawback that a significant level of production stoppage is always associated with it and that it is necessary to initiate a financially and technically high-outlay management process with not inconsiderable additional risks. The large volume of investment and the associated tax-related depreciation periods mean that not all sectors are able to dispense with durability in the same way.

WO 2005/052840 A1 discloses a method which allows design improvement measures either to be consciously avoided or else to be performed in particularly targeted and efficient fashion for the operator in terms of an increase in value retention.

In this context, the value retention of an installation is understood to be a variable which firstly covers the installation's replacement value or current market value but also and quite importantly the business management benefit of the installation as the capability of making a profit with the installation at present and in future at the installation's site, and under the prevailing economic and legal constraints. The last aspect mentioned means that the value retention can also be considered as the payment of interest on the tied capital. The value retention can be expressed by an Ebit (Earnings Before Interest and Taxes) and depends generally on many factors, including many technical influencing variables, however.

The known method involves design measures on an installation being identified which alter the value of at least one technical measured variable in the installation so as to increase the value retention of the installation. In this context, this at least one technical measured variable is ascertained in a first step. In a second step, design measures on the installation are identified which can be used to alter the value of the at least one measured variable so as to increase the value retention of the installation. Next, the increase in the value retention of the installation by the design measures is ascertained in a third step and finally the design measures are implemented in a fourth step.

By way of example, the at least one technical measured variable whose alteration in value would increase the value retention of the installation can be ascertained by virtue of those technical measured variables which jointly determine the value retention of a specific installation being identified, then the actual state of this installation being recorded by measurement of the identified measured variables and being compared with a stipulated benchmark.

The question of which measured variables are crucial for determining business management benefit in the specific case, i.e. for a specific installation or for a specific process, depends on the type of installation and its technological environment. In many cases, these include the installation's scrap rate, its efficiency, its downtimes, its availability, times required for adjusting to a new or different product, its power and water consumption, the time required for servicing steps, and many other measured variables. Experience shows that the technical effect on the business management benefit of an installation can in many cases be recorded by approximately 100 to 200 significant technical measured variables.

Preferably, the steps of measured variable recording up to measurement of the state of the installation using the benchmark are performed much more frequently (by at least a factor of 3) than the subsequent method steps. This means that the installation operator always has an up-to-date benchmark, knows the respective current state of the installation in relation to the state of similar installations, and does not run the risk that the installation to be examined will be measured using an obsolete scale. Many of the work steps required for stipulating a benchmark can also be performed separately from and to a large extent independently of state recording on an installation. For the currency of the information, however, the aforementioned revision frequency is recommended, however.

### SUMMARY OF INVENTION

The invention is based on the technical problem of specifying a method which allows, to an even better extent than previously, design improvement measures either to be consciously avoided or else to be performed in particularly targeted and efficient fashion for the operator in terms of increasing the value retention of the installation. In this context, the method should be implementable at least partly using a computer system and by a computer program.

Another technical problem is to adjust technical influencing variables in the installation reliably to an optimum value in the long term.

This object is achieved by a method in accordance with the claims. Advantageous refinements of the method are the subject matter of the claims.

In the case of the inventive method, the design measures for increasing the value retention of the installation are derived from one or more technical influencing variables for the technical measured variable. In this context, a technical influencing variable is understood to mean a technical installation variable which has an influence on the value of the measured variable. Besides technical influencing variables or installation variables, it is also possible to consider technological and business management influencing variables or installation variables, however. In a pickling/tandem line in a rolling mill, examples of influencing variables for an “availability rate” measured variable are changes of roller on account of faults, band tears, downtimes on account of acid discharge. Examples of influencing variables for a “rate of speed” measured variable are speed reductions on account of hum, power consumption and faulty welding seams. Hence, step a) identifies at least one technical influencing variable which has an influence on the technical measured variable, and then step b) identifies design measures on the installation which can be used to influence the at least one technical influencing variable such that the value of the at least one technical measured variable is altered so as to increase the value retention of the installation.

The invention is also based on the insight that particularly accurate ascertainment of the change in the value retention as a result of the design measures is possible only by virtue of not just the influence of this at least one influencing variable on the value retention but also the influence of other influencing variables in the installation which are influenced by the design measures being taken into account in the ascertainment of the change in the value retention of the installation. Hence, step c) identifies further technical influencing variables for the value retention of the installation which have their value altered by the design measures. Next, step d) ascertains the changes in the values of the technical influencing variables on account of the design measures, and then step e) ascertains the change in the value retention of the installation which is linked to the changes in the values of the influencing variables. It is therefore possible to identify and perform those design measures which adjust the technical influencing variables in optimum fashion in terms of an increase in the value retention of the installation. The inventive method can therefore be used to set up a connection between the technology of the installation and the business management of the installation.

In another step, the change in the value retention can be compared with the outlay (e.g. the investment costs) for the design measures and in this way the profitability of the design measures can be ascertained.

The change in the value retention of the installation can be ascertained in step e) by virtue of cost and yield variables in the installation which are altered upon changes in the values of the influencing variables being identified and then the change in the value retention of the installation being ascertained by ascertaining the changes in the values of the cost and yield variables on account of the changes in the values of the influencing variables. In this context, cost variables are understood to mean variables in connection with the input of the installation, i.e. costs for personnel, power, raw materials, semi-finished products etc. This input is converted into an output by the installation. In the case of a cold rolling mill, the output is various cold-rolled bands with the parameters of quantity in time and quality. Yield variables are understood to be variables in connection with the output of the installation, i.e. the yields from the installation's throughput, in the case of the cold rolling mill from the sale of the cold-rolled bands. The change in the value retention can be expressed from the difference between the changes in the values of the yield variables and the changes in the values of the cost variables, i.e. in the form of an Ebit.

Uncertainties in the value changes of technical influencing variables and/or cost and yield variables over time can be taken into account by virtue of the uncertain value changes over time being allocated a respective probability distribution for their value change over time and these probability distributions being used to ascertain a probability distribution for the change in the value retention of the installation over time. The variables with such uncertainties include, in particular, market-influenced cost and yield variables (e.g. costs for raw materials and power and also sales quantities and attainable prices for goods produced). A probability distribution is a function which indicates the probability with which a random variable assumes values in given ranges. The probability for the whole value range for the random variable has the value one.

By comparing the probability distribution for the change in the value retention of the installation with the financial outlay which is required for the design measures, it is possible to ascertain a probability distribution for the profitability of the design measures and hence also for the risks associated with performing the design measures. This allows a risk profile with calculated limit values to be obtained which can be used as a basis for decision for performing the design measures.

Preferably, the probability distribution for the change in the value retention is ascertained by virtue of random values for the uncertain influencing variables over time being produced iteratively on the basis of the respective allocated probability distribution, and the associated change in the value retention of the installation being ascertained. A method of this kind is known in the literature by the term “Monte Carlo simulation”.

By altering the value of a single influencing variable while simultaneously keeping the values of all other influencing variables constant, it is possible to ascertain the magnitude of the influence of this one influencing variable on the value retention of the installation. It is therefore possible to identify the influencing variables with the greatest influence on the change in the value retention and to orient the design measures to these influencing variables.

The method explained above can be implemented at least partly using a computer system. This system first of all comprises means for inputting changes in values of influencing variables for the value retention of a specific installation, for example a keyboard, or a serial or parallel interface, or a USB port. The system also comprises means for ascertaining the change in the value retention of the installation on account of the changes in the values of the influencing variables. This means may be a microprocessor which resorts to data in a main memory and/or a hard disk store.

Preferably, the computer system also comprises means for inputting a value for the financial outlay for design measures for changing the values of the influencing variables. This means may likewise be the aforementioned keyboard, or serial or parallel interface, or USB port, for example. The system also comprises means for comparing the change in the value retention of the installation with the financial outlay for the design measures in order to ascertain a profitability of the design measures. This means may likewise be the aforementioned microprocessor which resorts to data in a main memory and/or hard disk store.

The computer system may also comprise means for identifying cost and yield variables in the installation which are altered upon changes in the values of the influencing variables, and means for ascertaining the changes in the values of the cost and yield variables on account of the changes in the values of the influencing variables in order to ascertain the change in the value retention of the installation. These means may likewise be the aforementioned microprocessor which resorts to data in a main memory and/or hard disk store.

To take account of uncertain changes in values of influencing variables over time, the system may comprise means for allocating probability distributions for the changes in values of technical influencing variables and/or cost and yield variables for the value retention of the installation over time and means for ascertaining a probability distribution for the change in the value retention of the installation from the probability distributions of the technical influencing variables and/or cost and yield variables. By way of example, the allocation means are a screen in combination with the aforementioned keyboard, or serial or parallel interface, or USB port. The second-mentioned means may likewise be the aforementioned microprocessor which resorts to data in a main memory and/or hard disk store.

The inventive method can be implemented at least partly using a computer program. This program carries out the following steps:
a) it asks a user for changes in values of influencing variables for the value retention of a specific installation, which the user inputs using a keyboard, for example,
b) it ascertains the change in the value retention of the installation on account of the changes in the values of the influencing variables.

The program may also perform the following additional steps:
it asks a user for a value for the outlay for the design measures, which the user inputs using a keyboard, for example,
it compares the change in the value retention with the value for the outlay for the design measures and ascertains the profitability of the design measures therefrom.

For the purpose of ascertaining the change in the value retention, the program is able to identify cost and yield variables in the installation which are altered upon changes in the values of the influencing variables and is able to use changes in the values of the cost and yield variables on account of changes in the values of the influencing variables to ascertain the change in the value retention of the installation.

In addition, the program can ask a user for probability distributions for the changes in values of technical influencing variables and/or cost and yield variables for the value retention of the installation, which the user inputs using a keyboard, for example, or selects from a selection menu offered by the program, and can ascertain a probability distribution for the change in the value retention of the installation from the selected probability distributions.

The program may be stored on a data storage medium such as a CD or DVD, may be stored in a computer memory, or may be transmitted from computer to computer by means of an electrical carrier signal. The latter can be done in a network such as a LAN, WLAN or the Internet, for example.

### BRIEF DESCRIPTION OF THE DRAWINGS

The invention will be explained in more detail below with reference to exemplary embodiments in conjunction with the figures, in which:

FIG. 1 shows the constraints to which a cold rolling mill is subject,

FIG. 2 shows a flowchart to illustrate how an inventive method is carried out,

FIG. 3 shows an example of a probability distribution for uncertain influencing, cost or yield variables over time,

FIG. 4 shows an example of ascertainment of a probability distribution for the change in the value retention of an installation,

FIG. 5 shows an example of expected values for the increase in the value retention of an installation and the return on an investment without taking account of changes in the measured variables over time,

FIG. 6 shows an example of the capital values and pay-off times for a plurality of design measures assuming fixed. values for the change in uncertain influencing variables over time,

FIG. 7 shows an example of the capital values and pay-off times for the design measures in FIG. 6 when using probability distributions for the change in uncertain influencing variables over time,

FIG. 8 shows a computer system for carrying out the invention.

### DETAILED DESCRIPTION OF INVENTION

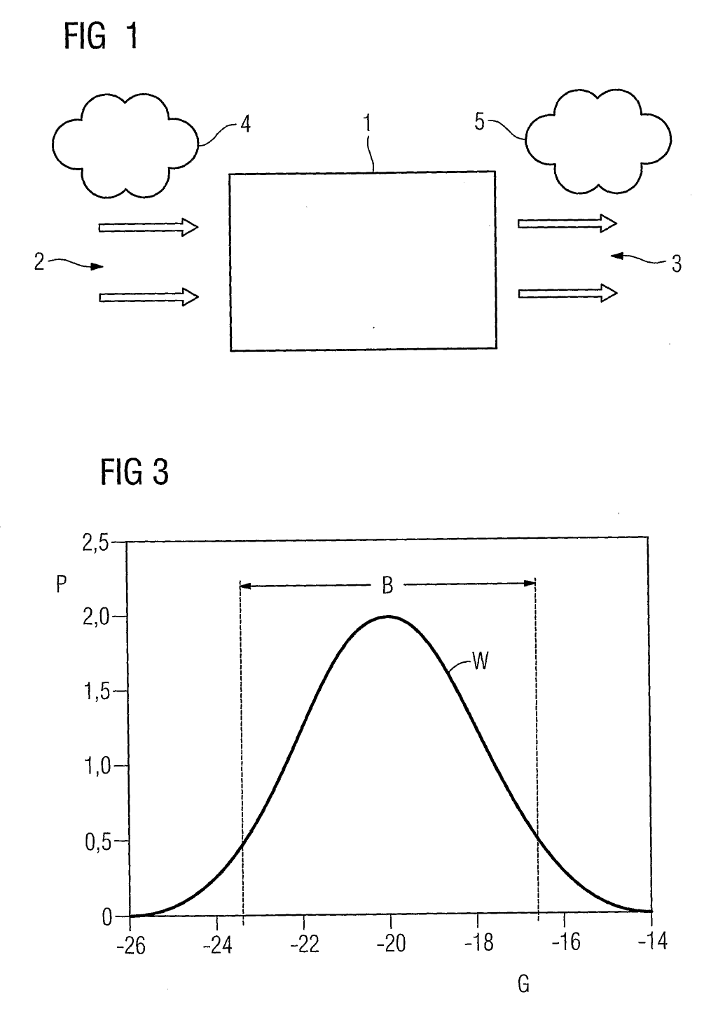

FIG. 1 shows the constraints to which an installation 1 for producing band steel for the automobile industry in the form of a pickling/tandem line, or a method carried out using installation 1, is subject. The installation 1 receives an input 2 in the form of personnel, power, media, raw materials, semi-finished products etc. which is converted into an output 3 by the installation 1. Since a cold rolling mill is involved, the output 3 is various cold-rolled bands. The various components of the input 2 can be associated with the factor markets 4 which are relevant to the specific installation. The various components of the output 3 can also be associated with the product markets 5 which are relevant to the specific installation 1.

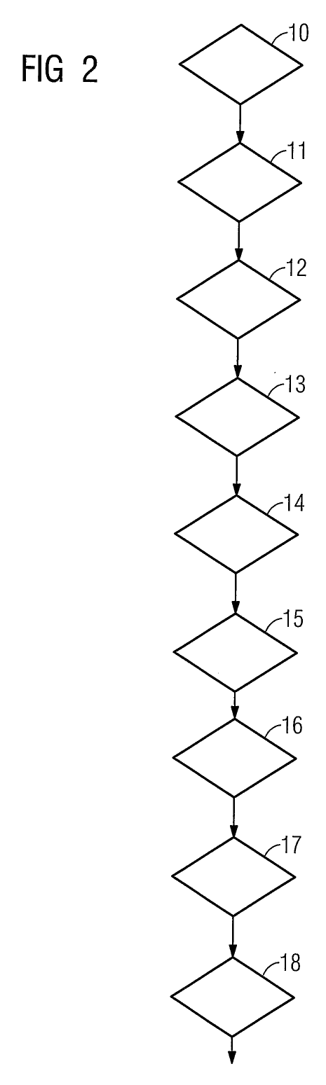

FIG. 2 is intended to be used to describe a method sequence based on the invention.

Step 10 ascertains at least one technical measured variable whose change in value would increase the value retention of a specific installation. This can be done using the method described in WO 2005/052840 A1, for example. By way of example, this measured variable is the availability of the installation 1.

Next, step 11 identifies technical influencing variables for the at least one technical measured variable, in this case the availability. Technical influencing variables are power supply failures, regulating inaccuracies, wear or leakage, for example. These affect the times for servicing and maintenance, fault searches, repair times for drives, rollers or cutters, stoppage times on account of band tears or seam tears, etc. in the installation 1. Other influencing variables are the stock of spare parts, the qualification of the employees and the quality of the input material, for example.

Next, step 12 identifies design measures on the installation 1 which can be used to influence these influencing variables such that the value of the at least one technical measured variable is altered so as to increase the value retention of the installation. A design measure of this kind might be replacement of an old DC motor with a modem asynchronous motor, for example. The modem asynchronous motor is more tolerant toward fluctuations in the power supply, is less susceptible to fault and requires less servicing, which means that it could be used to increase the availability of the installation 1.

Step 13 then identifies further technical influencing variables for the value retention of the installation which are likewise influenced by the design measures. By way of example, the asynchronous motor could improve the regulating accuracy of the whole installation 1.

Next, step 14 identifies cost and yield variables in the installation which are altered upon changes in the values of the influencing variables. To this end, the technical influencing variables can be divided into variables which relate to the input 2 for the installation 1 and variables which influence the output 3 of the installation 1.

By way of example, the variables which relate to the input of the installation 1 include the requirement for power, raw materials, wearing materials, personnel etc. These variables can in turn be allocated costs, e.g. power costs, raw materials costs, wearing materials costs, personnel costs.

The output of the installation 1 is determined by the throughput of the installation 1, i.e. the quantity of cold-rolled bands of desired quality. Influencing variables therefor relate to the availability, the quality or the speed or performance of the installation 1. The availability, the quality and the speed or performance of the installation 1 in turn determine the overall equipment efficiency (OEE) of the installation 1. When the DC motor is being replaced by an asynchronous motor, an example of another output-relevant influencing variable might be the maximum speed of the installation 1 and, via the improvement in the regulating accuracy, the quality of the cold-rolled bands. In turn, linked to the output are the yields which can be attained with the installation and which are dependent on the sales quantity, in this case the quantity of saleable cold-rolled bands, and the price which can be attained for them.

Step 15 now ascertains the changes in the values of the technical influencing variables identified in steps 11 and 13 on account of the design measures, and step 16 ascertains the changes in values of the identified cost and yield variables on account of the changes in the values of the technical influencing variables. In this context, steps 14 and 15 can also be performed in reverse order.

The costs can be divided into fixed costs (e.g. personnel costs) and variable costs influenced by the market (e.g. power costs, raw materials costs, wearing materials costs). The development of the variable, market-influenced costs over time (e.g. over the next 10 years) has associated high levels of uncertainty. The same applies on the yield side for the sales quantity and the prices which can be attained. The change in value of the technical influencing variables (e.g. the servicing requirement for the aforementioned asynchronous motor) over time may also be uncertain.

In step 16, the influencing variables and the cost and yield variables with an uncertain development over time are therefore allocated a respective probability distribution for their change in value over time, and step 17 uses these probability distributions to ascertain a probability distribution for the change in the value retention of the installation over time (e.g. as an Ebit in euros or another currency).

A probability distribution specifies the probability with which a variable assumes particular values within a time interval. By way of example, FIG. 3 shows a probability distribution W for the change in a variable G over time, e.g. a technical influencing variable such as cos φ, which determines the power consumption of a drive, or a cost variable such as the power costs, for a time interval of 10 years, for example. In this context, the probability distribution W allocates each value of the variable G a value for its probability of occurrence P. Such a distribution can be used to define a range B within whose limits the value of the variable G has a particular probability of variation. Thus, in the case in FIG. 3, the value of the variable G has a probability of 90% of being within the range B and has a respective probability of 5% of being above or below the range B.

Finally, the financial outlay, e.g. the investment costs, for the design measures is compared in step 18 with the probability distribution, ascertained in step 16, for the increase in the value retention of the installation as a result of the design measures, and the result is used to ascertain the profitability of the design measures. If the design measure is profitable, the design measure can then be performed.

Preferably, the cash values of the future Ebits are ascertained in order to ascertain profitability on the basis of the capital value method. If the sum of these cash values is greater than the investment sum for the design measures then the capital value is positive and hence the design measures are profitable.

The method sequence shown in FIG. 2 can therefore be used to adjust the influencing variables to an optimum value in terms of the value retention of the installation 1.

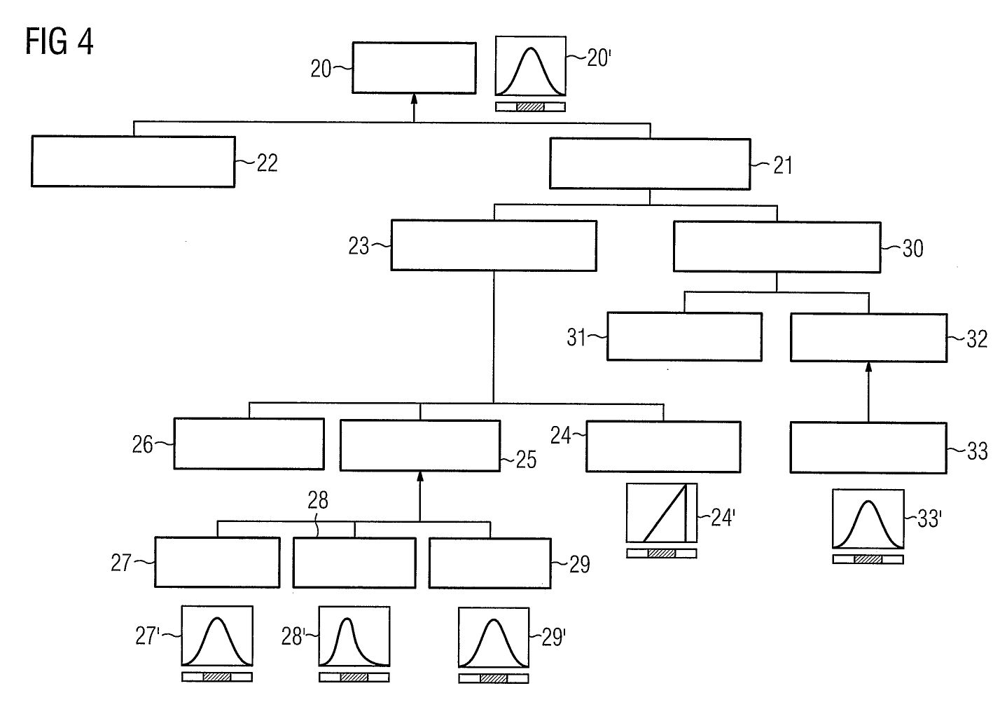

FIG. 4 shows, by way of example, how a probability distribution 20′ for the quantitive change in the Ebit 20 of the installation 1 can be ascertained in step 17. The Ebit 20 is determined from the (variable) yields 21 minus the fixed costs 22, which are formed by the personnel costs for servicing and operating the installation 1, for example. The (variable) yields 21 are determined by the variable yields per good produced 23 and the output 30 of the installation 1.

The variable yields per good produced 23 are in turn determined by the difference comprising the average selling price per item 24 minus the item costs 25 and the transport costs 26. The item costs 25 comprise power costs 27, raw materials costs 28 and consumable materials costs 29.

The output 30 of the installation 1 is obtained from the maximum possible production quantity 31 minus the losses 32 on account of technical influences 33, such as band tears, profile defects, stoppage of motors with effects on availability, speed and quality of production.

The development of the production losses 32 over time is uncertain on account of uncertainties about the development of the technical influencing variables 33 over time. The development of power costs 27, raw materials costs 28 and consumable materials costs 29 and also of the average selling price 24 over time is also uncertain on account of their market dependency. The average selling price 24, the power costs 27, raw materials costs 28 and consumable materials costs 29, and also the technical influencing variables 33, therefore have a respective associated probability distribution 24′, 27′, 28′, 29′ or 33′ from which the probability distribution 20′ for the quantitative change in the Ebit 20 of the installation is ascertained. This is done by iteratively producing random values for the uncertain variables in line with the respective associated probability distribution, while keeping the aforementioned fixed magnitudes constant, and producing the respective Ebit therefor. After several hundred to a thousand passes, the results ascertained thereby produce a probability distribution for the Ebit. Such a method is known by the term “Monte Carlo method”, for example.

By keeping all the variable magnitudes apart from a single variable magnitude constant, it is also possible to effect quantitative ascertainment of the magnitude of the influence of this one variable magnitude on the change in the Ebit.

From the probability distribution for the change in the Ebit and the investment costs for the design measures, it is possible to ascertain a probability distribution for the development of the cash flow and from this the pay-off time for the investment. The capital value (also net cash value) is the sum of the discounted cash flow plus the investment costs. The graph shown in FIG. 5 shows the development of the cash flow CF over time t in years. The investment is made at time t=0. For the cash flow CF, taking into account the probability distribution for the Ebit results in a breadth of fluctuation, with the cash flow having a probability of 90% of varying in the range B and a probability of 10% of varying in the range B′. As FIG. 5 reveals, the break-even point and hence the pay-off time t can fluctuate between 3.5 and 4.5 years.

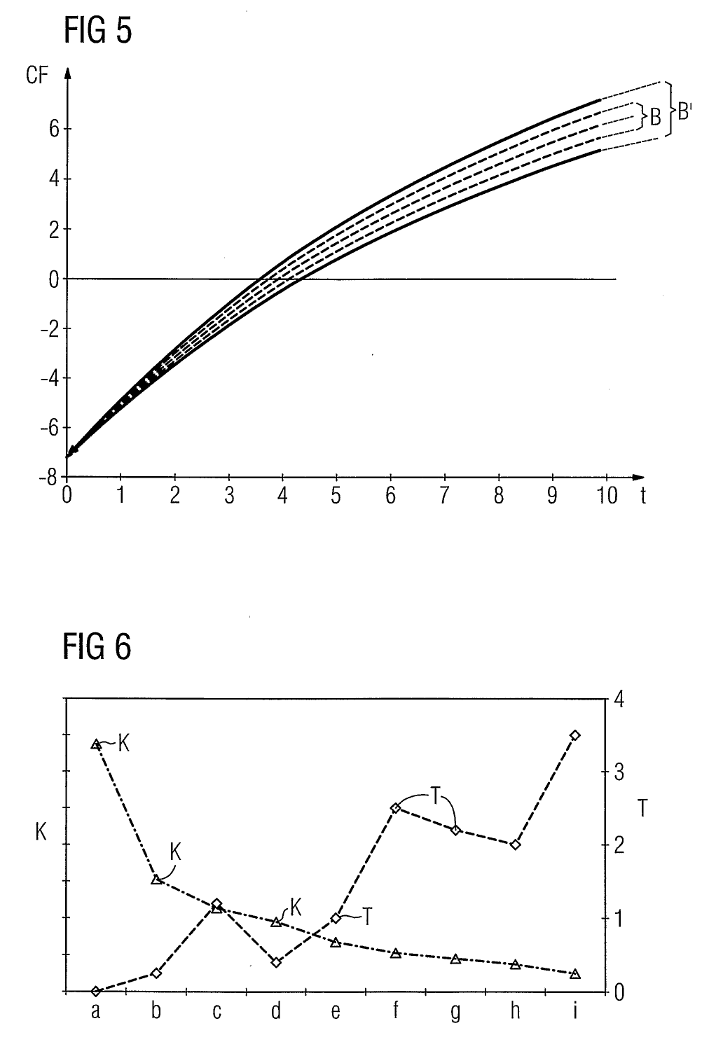

The graph in FIG. 6 shows the respective capital values K and pay-off times T by way of example for 9 design measures a-i, with fixed values for the uncertain variable magnitudes having been assumed for the development of said variable magnitudes over time. Accordingly, fixed values are obtained for the capital values and pay-off times.

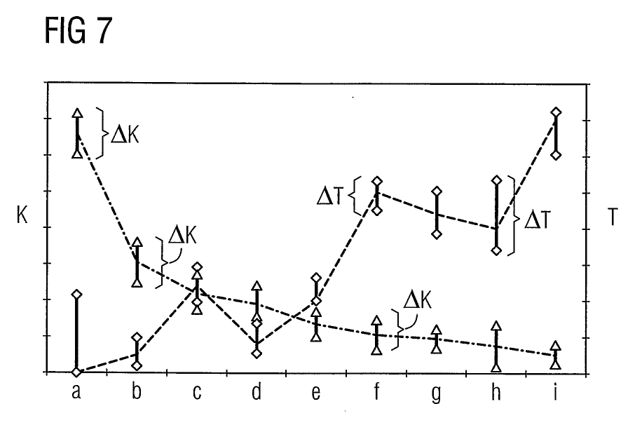

The graph in FIG. 7 shows the respective capital values K and pay-off periods T by way of example for the 9 design measures a-i in FIG. 6 when probability distributions for the uncertain variable magnitudes are used for the development of said variable magnitudes over time. Accordingly, respective probability ranges ΔK and ΔT which present the possible breadths of fluctuation for the profitability of the design measures are obtained for the capital values and pay-off times.

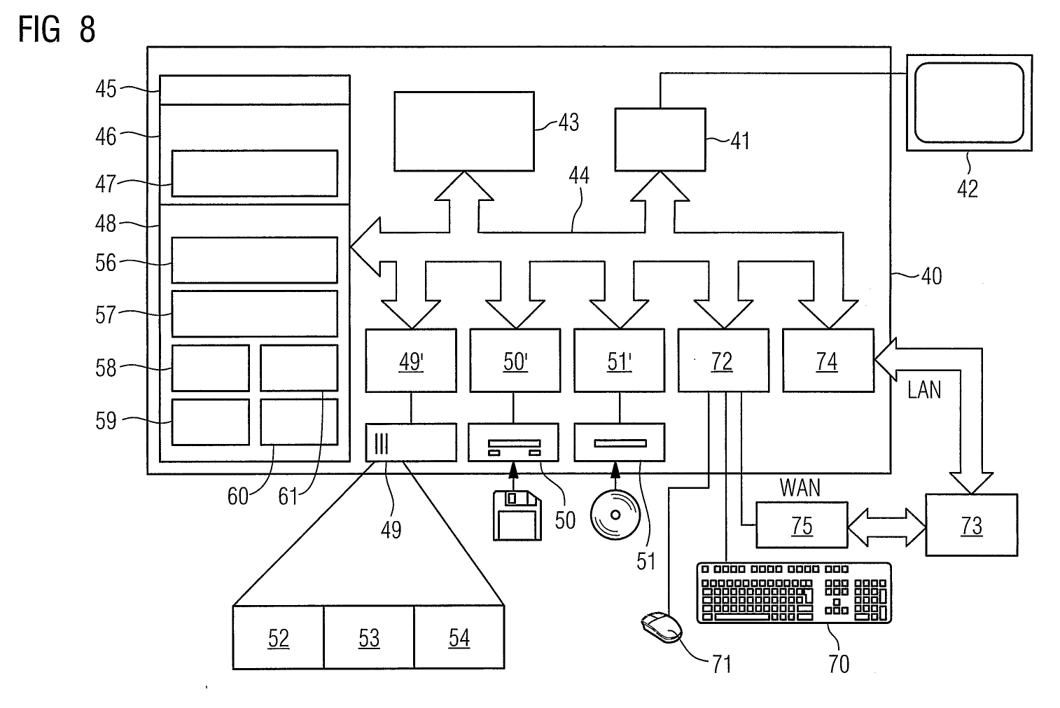

FIG. 8 shows an inventive computer system, having a computer 40 whose outputs are made to a screen 42 via a graphics card 41. The computer 40 has a central microprocessor 43 which is coupled to the system memory 45 via the system bus 44. The system memory 45 comprises the ROM (Read Only Memory) 46, the BIOS (Basic Input/Output System) 47 and the main memory in the form of a RAM (Random Access Memory) 48. The computer 40 also has a hard disk 49, a disk drive 50 and a DVD drive 51. The hard disk 49, the disk drive 50 and the DVD drive 51 are coupled to the system bus 44 via respective interfaces 49′, 50′ and 51′.

The hard disk 49 stores the operating system 52, the inventive computer program 53 and data 54. When the program 53 is called, it is loaded into the main memory 48 where is has a first module 56 for ascertaining at least one technical measured variable whose change in value would increase the value retention of a specific installation, a second module 57 for identifying at least one technical influencing variable for the technical measured variable, a third module 58 for identifying design measures on the installation for influencing the at least one technical influencing variable such that the value of the at least one technical measured variable is altered so as to increase the value retention of the installation, a fourth module 59 for identifying further technical influencing variables for the value retention of the installation which have their value altered by the design measures, and a fifth module 60 for ascertaining the changes in the values of the technical influencing variables on account of the design measures.

A sixth module 61 is used to ascertain the change in the value retention of the installation (in euros or in another currency), which is linked to the changes in the values of the influencing variables, by identifying cost and yield variables for the installation which are altered upon changes in the values of the influencing variables, and to ascertain the changes in the values of the cost and yield variables (in euros or another currency). The module 61 is also used to allocate probability distributions to technical influencing variables and/or cost and yield variables with uncertain changes in value over time and to ascertain a probability distribution for the change in the value retention of the installation over time from these probability distributions.

Further program modules may be stored in the RAM, for example a module for comparing the change in the value retention with the outlay for the design measures in order to ascertain the profitability of the design measures.

During execution of the program 53, the computer 40 requests changes in values of influencing variables for the value retention of a specific installation, probability distributions for the changes in values of influencing variables and/or cost and yield variables and a value for the financial outlay for the design measures. These data can be typed in by the user using a keyboard 70 supported by a computer mouse 71, the data being sent to the main memory 48 via the serial interface 72 and the system bus 44. Alternatively, these data may already be supplied to the module 60 or by a server 73. If the computer 40 is part of a LAN then the data arrive on the system bus 44 via a network card 74. If the computer 40 is part of a WAN then the data are transferred to the system bus 44 via a modem or router 75 and via the serial interface 72.

1-16. (canceled)

17. A method for modernizing durable industrial production installations, in which design measures on a specific installation are identified which alter the value of at least one technical measured variable so as to increase the value retention of the installation, comprising:
identifying a technical influencing variable for the technical measured variable;
identifying design measures on the installation for influencing technical influencing variable such that the value of the technical measured variable is altered so as to increase the value retention of the installation;
identifying further technical influencing variables for the value retention of the installation which have their value altered by the design measures;
ascertaining the changes in the values of the technical influencing variables on account of the design measures; and
ascertaining the change in the value retention of the installation which is linked to the changes in the values of the influencing variables.

18. The method as claimed in claim 17, further comprising:
comparing the change in the value retention with the outlay for the design measures in order to ascertain the profitability of the design measures.

19. The method as claimed in claim 18, further comprising:
identifying cost and yield variables for the installation which are altered upon changes in the values of the influencing variables, and
ascertaining the changes in the values of the cost and yield variables on account of changes in the values of the influencing variables in order to ascertain the change in the value retention of the installation.

20. The method as claimed in claim 19, wherein technical influencing variables and/or cost and yield variables with uncertain value changes over time are allocated a respective probability distribution for their value change over time and these probability distributions are used to ascertain a probability distribution for the change in the value retention of the installation over time.

21. The method as claimed in claim 20, wherein in order to ascertain the probability distribution for the change in the value retention of the installation, random values for the uncertain influencing variables over time are produced iteratively on the basis of the respective allocated probability distribution and these are used to ascertain the associated change in the value retention of the installation.

22. The method as claimed in claim 21, wherein by altering the value of a single influencing variable while simultaneously keeping the values of all other influencing variables constant, the magnitude of the influence of this one influencing variable on the increase in value retention is ascertained.

23. A computer system for modernizing durable industrial production installations, comprising:
a value inputting device for inputting changes in values of influencing variables for the value retention of a specific installation; and
a value change determining device that ascertains a change in the value retention of the installation on account of the changes in the values of the influencing variables.

24. The computer system as claimed in claim 23, further comprising
a financial outlay inputting device for inputting a value for a financial outlay for design measures for changing the values of the influencing variables,
a comparing device that compares the change in the value retention of the installation with the financial outlay for the design measures in order to ascertain the profitability of the design measures.

25. The computer system as claimed in claim 24, further comprising:
an identifying device that identifies cost and yield variables for the installation which are altered upon changes in the values of the influencing variables,
a change determining device that ascertains the changes in the values of the cost and yield variables on account of the changes in the values of the influencing variables in order to ascertain the change in the value retention of the installation.

26. The computer system as claimed of claim 25, wherein
a probability distribution allocating device that allocates probability distributions for changes in values of influencing variables and/or cost and yield variables for the value retention of the installation over time, and
a probability distribution device that ascertains a probability distribution for the change in the value retention of the installation from the probability distributions for the influencing variables and/or cost and yield variables.

27. A computer program for modernizing durable production installations, comprising:
requesting changes in values of influencing variables for the value retention of a specific installation; and
ascertaining changes in the value retention of the installation on account of the changes in the values of the influencing variables.

28. The computer program as claimed in claim 27, further comprising
requesting a value for the financial outlay for the design measures, and
comparison of the change in the value retention with the value for the outlay for the design measures in order to ascertain the profitability of the design measures.

29. The computer program as claimed in claim 28, further comprising
identifying cost and yield variables for the installation altered upon changes in the values of the influencing variables, and
ascertaining changes in the values of the cost and yield variables on account of the changes in the values of the influencing variables in order to ascertain a change in the value retention of the installation.

30. The computer program as claimed in claim 29, further comprising:
requesting probability distributions for the changes in values of influencing variables and/or cost and yield variables for the value retention of the installation, and
ascertaining a probability distribution for the change in the value retention of the installation from the probability distributions.
